(19) United States
(12) Patent Application Publication
(10) Pub. No.: US 2026/0229714 A1
(43) Pub. Date: Aug. 6, 2026

(54) BATTERY PACK

(71) Applicant: BOMBARDIER RECREATIONAL PRODUCTS INC., Valcourt (CA)

(72) Inventor: Denis BOURASSA, Valcourt (CA)

(21) Appl. No.: 19/465,290

(22) Filed: Jan. 30, 2026

Related U.S. Application Data
(60) Provisional application No. 63/752,212, filed on Jan. 31, 2025.

(51) Int. Cl. H01M 50/505; H01M 10/46; H01M 50/51

(52) U.S. Cl. CPC H01M 50/505; H01M 50/51; H01M 10/46; H01M 2220/20

(57) ABSTRACT

A battery pack includes three low-voltage units, output and interconnection terminals connected to the low-voltage units, and a conductor assembly including first and second conductors and an electrically non-conductive cover covering the first and second conductors. With the first conductor electrically connected to first and second interconnection terminals, and the second conductor electrically connected to third and fourth interconnection terminals, a voltage greater than a pre-determined voltage is present between two terminals. The conductor assembly is configured to remove the conductors together with the cover, thereby electrically disconnecting the conductors from the interconnection terminals; and to install the conductors together with the cover, thereby electrically connecting the conductors to the interconnections terminals, the cover covering the interconnection terminals. In response to the one of the conductors being disconnected from one of the interconnection terminals, voltage between any two terminals is less than or equal to the pre-determined voltage.

### CROSS-REFERENCE TO RELATED APPLICATION

The present application claims priority to U.S. Provisional Patent Application No. 63/752,212, filed Jan. 31, 2025, entitled “Battery Pack”, which is incorporated by reference herein in its entirety.

### FIELD OF TECHNOLOGY

The present technology relates to battery pack configurations.

### BACKGROUND

The increasing popularity of electric vehicles has led to a greater demand for the repair and servicing of their various components, including battery packs.

Traditional battery packs can be prone to damage during their assembly and/or during their servicing. These battery packs include numerous electronic components such as cells that are vulnerable to high-voltage exposure. The cells may get damaged if subjected to a short circuit. The damage may cause the cells to overheat and to trigger internal protective devices. If a conductive tool or a conductive component, such as a dropped conductive fastener, contacts a high-voltage circuit, it can cause accidental arcing or short circuits, potentially leading to immediate and/or latent damage to the cells or to the other electronic components. Such latent damage may not be immediately detectable and may only become apparent after the battery pack has been reassembled and deemed operational.

Additionally, the process for assembling and disassembling traditional battery packs can have a lot of steps that can be time-consuming to perform, and if done incorrectly, can cause damage to components of the battery packs.

Accordingly, there exists a need for an improved battery pack design that mitigates the aforementioned deficiencies.

### SUMMARY

According to one aspect of the present technology, there is provided a battery pack including a first low-voltage unit, a second low-voltage unit, a third low-voltage unit, a plurality of terminals and a conductor assembly. The plurality of terminals is connected to the first low-voltage unit, to the second low-voltage unit, and to the third low-voltage unit. The plurality of terminals includes two output terminals, and a first interconnection terminal connected to the first low-voltage unit, a second interconnection terminal connected to the second low-voltage unit, a third interconnection terminal connected to the second low-voltage unit, and a fourth interconnection terminal connected to the third low-voltage unit. The conductor assembly includes a first conductor selectively electrically connected to the first interconnection terminal and to the second interconnection terminal, and a second conductor selectively electrically connected to the third interconnection terminal and the fourth interconnection terminal. With the first conductor electrically connected to the first interconnection terminal and to the second interconnection terminal, and the second conductor electrically connected to the third interconnection terminal and the fourth interconnection terminal, a voltage greater than a pre-determined voltage is present between two terminals of the plurality of terminals. The cover is connected to the first conductor and to the second conductor, and the cover is made of electrically non-conductive material. The cover covers the first and second conductors, and the first, second, third and fourth interconnection terminals. The conductor assembly is configured to remove the first conductor and the second conductor together with the cover, thereby electrically disconnecting the first conductor from the first interconnection terminal and from the second interconnection terminal, electrically disconnecting the second conductor from the third interconnection terminal and from the fourth interconnection terminal, and providing access to the first interconnection terminal, to the second interconnection terminal, to the third interconnection terminal and to the fourth interconnection terminal. The conductor assembly is configured to install the first conductor and the second conductor together with the cover, thereby electrically connecting the first conductor to the first interconnection terminal and to the second interconnection terminal, electrically connecting the second conductor to the third interconnection terminal and to the fourth interconnection terminal; and covering the first interconnection terminal, the second interconnection terminal, the third interconnection terminal and the fourth interconnection terminal. In response to the first conductor being disconnected from either the first interconnection terminal or from the second interconnection terminal and the second conductor being disconnected from either the third interconnection terminal or from the fourth interconnection terminal, the voltage between any two terminals of the plurality of terminals is less than or equal to the pre-determined voltage.

In some embodiments, the first conductor is selectively mechanically fastened to the first interconnection terminal and to the second interconnection terminal, and the second conductor is selectively mechanically fastened to the third interconnection terminal and to the fourth interconnection terminal.

In some embodiments, the first conductor and the second conductor are encased in the cover.

In some embodiments, the plurality of terminals further includes two other terminals, and the battery pack further includes a connection unit having the two other terminals, such that the connection unit is selectively electrically connected to the first low-voltage unit, to the second low-voltage unit, and to the third low-voltage unit.

In some embodiments, the connection unit includes at least one of a charger, an inverter, or a DC-DC converter.

In some embodiments, the first low-voltage unit, the second low-voltage unit, the third low-voltage unit and the connection unit are mechanically connected to one another.

In some embodiments, the pre-determined voltage is one of: 50 volts or 60 volts.

In some embodiments, at least one of the first conductor is a first busbar, and the second conductor is a second busbar; or the first low-voltage unit is a first battery module, the second low-voltage unit is a second battery module and the third low-voltage unit is a third battery module.

In some embodiments, at least one of the first low-voltage unit, the second low-voltage unit, or the third low-voltage unit includes at least two cells of lithium-ion type.

In some embodiments, the cover further covers the two output terminals.

According to another aspect of the present technology, there is provided a battery pack including a first low-voltage unit, a second low-voltage unit, a third low-voltage unit, a plurality of terminals, a first conductor assembly and a second conductor assembly. The plurality of terminals is connected to the first low-voltage unit, to the second low-voltage unit, and to the third low-voltage unit. The plurality of terminals includes two output terminals; and a first interconnection terminal connected to the first low-voltage unit, a second interconnection terminal connected to the second low-voltage unit, a third interconnection terminal connected to the second low-voltage unit, and a fourth interconnection terminal connected to the third low-voltage unit. The first conductor assembly is disposed on a first side of the battery pack, the first conductor assembly includes a first conductor and a first cover. The first conductor is selectively electrically connected to the first interconnection terminal and to the second interconnection terminal. The first cover is connected to the first conductor, and is made of electrically non-conductive material. The first cover covers the first conductor, the first interconnection terminal, and the second interconnection terminal. The second conductor assembly is disposed on a second side of the battery pack, the second conductor assembly including a second conductor and a second cover. The second conductor is selectively electrically connected to the third interconnection terminal and the fourth interconnection terminal. The second cover is connected to the second conductor, is made of electrically non-conducting material, and the covers the second conductor, the third interconnection terminal, and the fourth interconnection terminal. With the first conductor electrically connected to the first interconnection terminal and to the second interconnection terminal, and the second conductor electrically connected to the third interconnection terminal and the fourth interconnection terminal, a voltage greater than a pre-determined voltage is present between two terminals of the plurality of terminals. The first conductor assembly is configured to remove the first conductor together with the first cover, thereby electrically disconnecting the first conductor from the first interconnection terminal and from the second interconnection terminal, and providing access to the first interconnection terminal and to the second interconnection terminal. The second conductor assembly is configured to remove the second conductor together with the second cover, thereby electrically disconnecting the second conductor from the third interconnection terminal and from the fourth interconnection terminal, and providing access to the third interconnection terminal and to the fourth interconnection terminal. The first conductor assembly is configured to install the first conductor together with the first cover, thereby electrically connecting the first conductor to the first interconnection terminal and to the second interconnection terminal, and covering the first interconnection terminal and the second interconnection terminal. In response to the first conductor being disconnected from the first interconnection terminal and from the second interconnection terminal, the voltage between any two terminals of the plurality of terminals is less than or equal to the pre-determined voltage. The second conductor assembly is configured to install the second conductor together with the second cover, thereby electrically connecting the second conductor to the third interconnection terminal and to the fourth interconnection terminal; and covering the third interconnection terminal and the fourth interconnection terminal. In response to the first conductor being disconnected from either the first interconnection terminal or from the second interconnection terminal and the second conductor being disconnected from either the third interconnection terminal or from the fourth interconnection terminal, the voltage between any two terminals of the plurality of terminals is less than or equal to the pre-determined voltage.

In some embodiments, the first conductor is selectively mechanically fastened to the first interconnection terminal and to the second interconnection terminal, and the second conductor is selectively mechanically fastened to the third interconnection terminal and to the fourth interconnection terminal.

In some embodiments, the first conductor is encased in the first cover and the second conductor is encased in the second cover.

In some embodiments, the plurality of terminals further includes two other terminals, and the battery pack further comprises a connection unit having the two other terminals, such that the connection unit is selectively electrically connected to the first low-voltage unit, to the second low-voltage unit, and to the third low-voltage unit.

In some embodiments, the connection unit includes at least one of a charger, an inverter, or a DC-DC converter.

In some embodiments, the first low-voltage unit, the second low-voltage unit, the third low-voltage unit and the connection unit are mechanically connected to one another.

In some embodiments, the pre-determined voltage is one of 50 volts or 60 volts.

In some embodiments, at least one of the first conductor is a first busbar, and the second conductor is a second busbar; or the first low-voltage unit is a first battery module, the second low-voltage unit is a second battery module and the third low-voltage unit is a third battery module.

In some embodiments, at least one of the first low-voltage unit, the second low-voltage unit, or the third low-voltage unit includes at least two cells of lithium-ion type.

In some embodiments, the cover further covers the two output terminals.

Within the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

Additional and/or alternative features, aspects and advantages of embodiments of the present technology will become apparent from the following description and the accompanying drawings.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view taken from a top, front, left side of a battery pack according to an embodiment of the present technology;

FIG. 2A is a perspective view taken from a top, front, left side of the battery pack of FIG. 1, with an upper cover of the battery pack being omitted;

FIG. 2B is a perspective view taken from a top, front, left side of the battery pack of FIG. 2A, with a connection interface of the battery pack further being omitted;

FIG. 3 is a partially exploded perspective view taken from a top, front, left side of the battery pack of FIG. 2A;

FIG. 4 is a partially exploded perspective view taken from a top, front, right side of the battery pack of FIG. 2A;

FIG. 5A is a perspective view of a right busbar assembly of the battery pack of FIG. 4;

FIG. 5B is a partially exploded perspective view of the right busbar assembly of FIG. 5A;

FIG. 6A is partially exploded perspective view of the battery pack of FIG. 2A, with a bottom cover thereof also being omitted;

FIG. 6B is a partially exploded perspective view of a pair of battery modules of the battery pack of FIG. 2A;

FIG. 7 is a partially exploded perspective view taken from a bottom, rear, right side of a connection unit of the battery pack of FIG. 6A;

FIG. 8A is a rear elevation view of an upper right portion of the connection unit of FIG. 7, with a stopper of the connection unit being in an extended position and a locking member of the connection unit being in a locked position;

FIG. 8B is a rear elevation view of the upper right portion of the connection unit of FIG. 7, with the stopper being in the extended position and the locking member being in an unlocked position;

FIG. 9 is a partially exploded perspective view taken from bottom, rear, right side of the upper right portion of the connection unit of FIG. 7, with the stopper being in a retracted position;

FIG. 10 is a partially exploded perspective view taken from a bottom, rear, left side of the upper right portion of the connection unit of FIG. 7; and

FIG. 11 is a partially exploded perspective view taken from a top, front, left side of a battery pack according to an alternative embodiment of the present technology, with an upper cover being omitted.

It should be noted that, unless otherwise explicitly specified herein, the drawings are not necessarily to scale.

### DETAILED DESCRIPTION

The present technology will be described herein with respect to a battery pack 100 for powering an electric vehicle and, in particular, powersport vehicles. The battery pack 100 may be incorporated in a variety of electric vehicle types including, but not limited to, electric motorcycles, electric snowmobiles, electric all-terrain vehicles, two-wheeled straddle-seat electric vehicles, three-wheeled electric vehicles, electric side-by-side vehicles, four-wheeled electric vehicles, electric watercraft, etc. It is contemplated that at least some aspects of the present technology may also be used in electric vehicles other than electric powersport vehicles. It is further contemplated that the battery pack 100 may be used for powering devices other than electric vehicles.

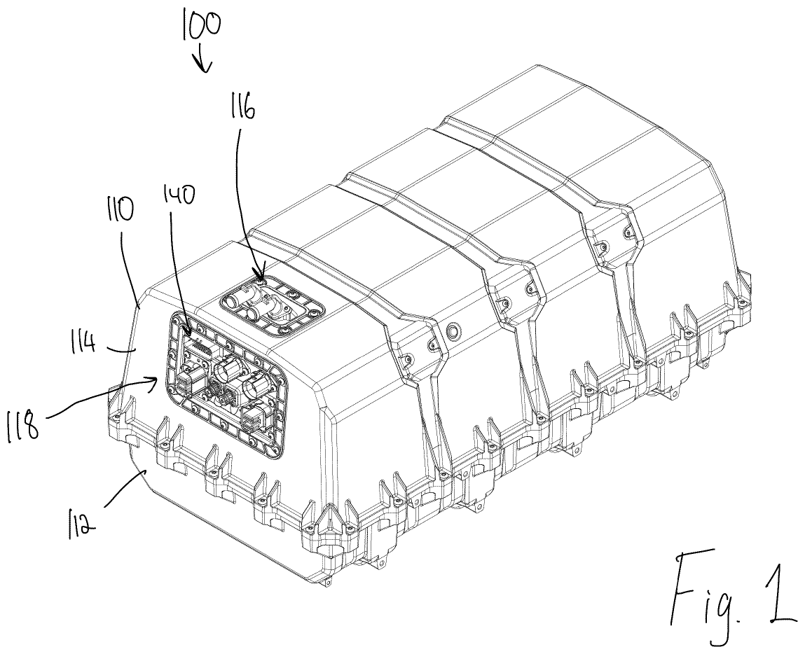

FIG. 1 depicts a top-side perspective external view of the battery pack 100 in accordance with a non-limiting embodiment of the present technology. The battery pack 100 includes a battery housing 110 for enclosing various components of the battery pack 100. In the illustrated embodiment, the battery housing 110 has a generally rectangular cuboid form, though it is contemplated that the battery housing 110 could be shaped differently depending on various factors, such as the available space and configuration of the electric vehicle.

The battery housing 110 includes a bottom cover 112 and an upper cover 114. The bottom and upper covers 112, 114 are selectively fastened to one another. It is contemplated that the battery housing 110 could include three or more covers. It is also contemplated that the bottom and upper covers 112, 114 could be connected together in a variety of different ways that allow for the selective attachment/detachment of the covers 112, 114, such as, for example, tabs, latches, spring fasteners, etc. It is contemplated that the material used for the top and bottom covers 112, 114 may include carbon-based materials, metal(s), metallic and/or carbon particle-infused composite(s), paramagnetic material(s), and may further incorporate a metallic screen, metallic wires, metallic tape, metallic sheets, metallic coating, etc.

The upper cover 114 defines a top aperture 116 and a front aperture 118. The top and front apertures 116, 118 are configured to receive components of the battery pack 100 therethrough.

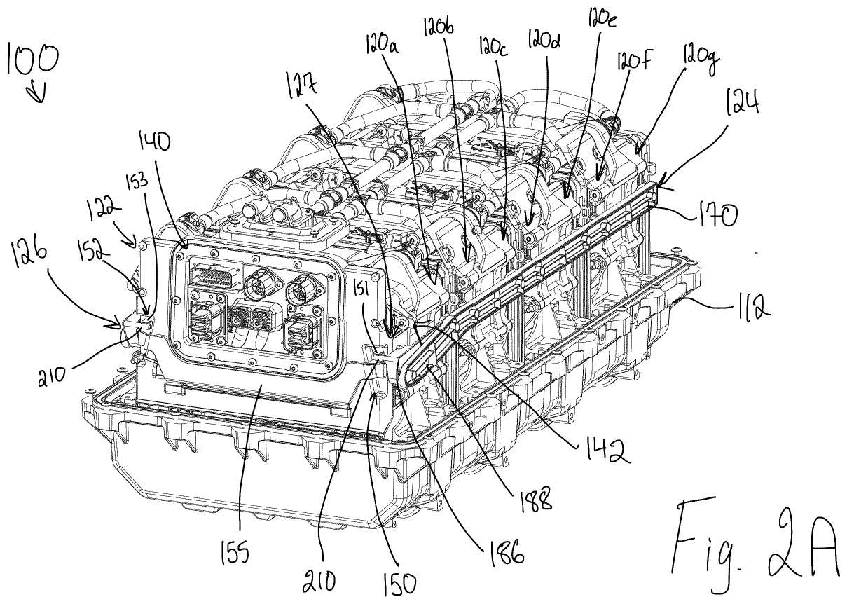

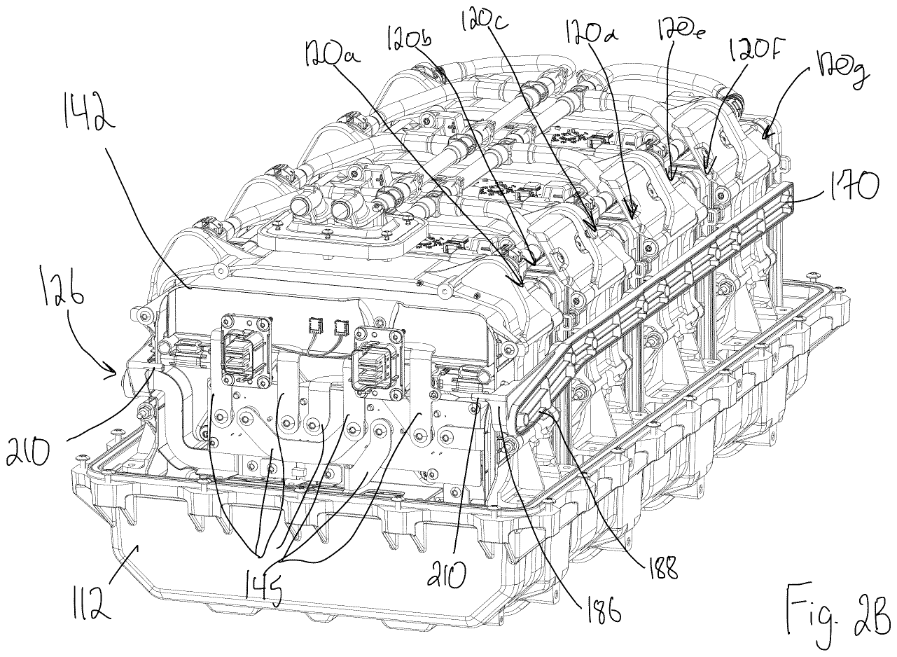

Referring to FIGS. 2A, 2B, 3 and 4, the battery pack 100 also includes battery modules 120a, 120b, 120c, 120d, 120e, 120f, 120g (collectively referred to as battery modules 120), a connection unit 122, a left conductor assembly 124, a right conductor assembly 126, and a retention assembly 127, which includes a left stopping assembly 128 and a right stopping assembly 129. As will be described below, the retention assembly 127 is configured to, in certain conditions, prevent connection of the battery modules 120 and either of the conductor assemblies 124, 126 to one another and prevent disconnection of the battery modules 120 and the connection unit 122 from one another.

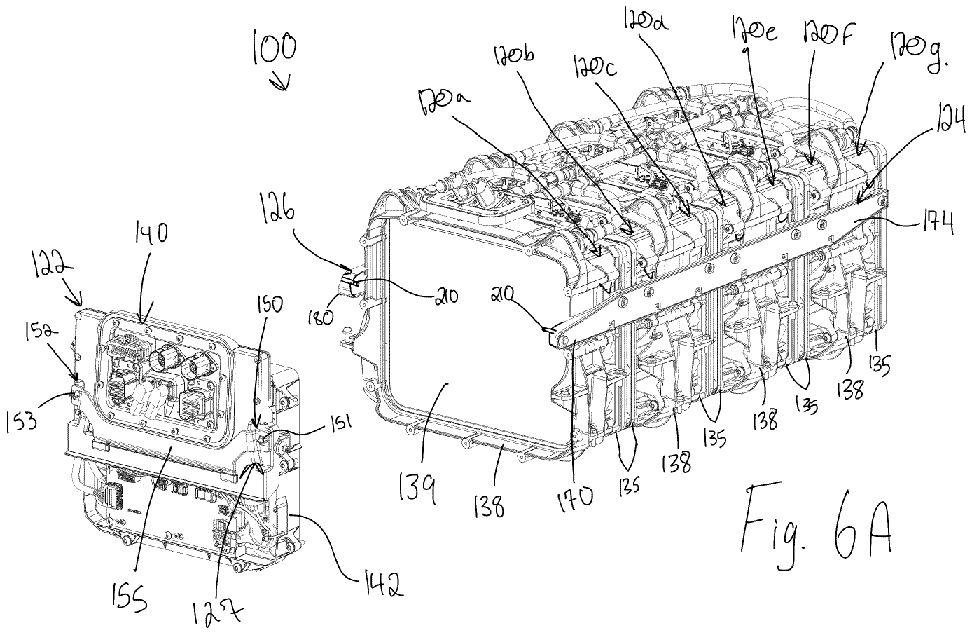

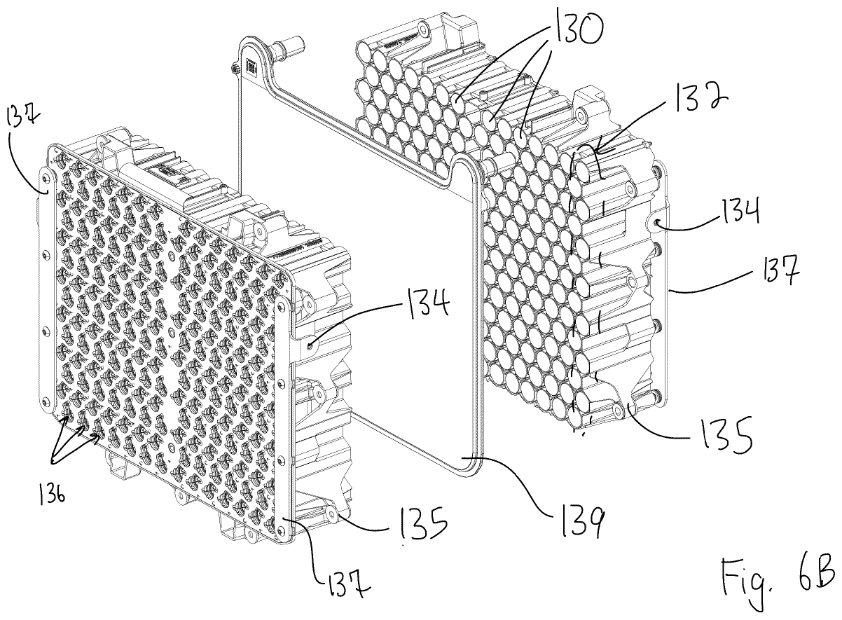

In the present embodiment, the battery pack 100 includes seven battery modules 120. It is contemplated that in other embodiments, the battery pack 100 may include two, three, four, five, six, eight or more battery modules 120. Referring to FIG. 6B, each battery module 120 includes cells 130, a holding matrix 135 holding the cells 130, and two terminals 134.

The cells 130 are lithium-ion cells 130, though it is contemplated that other types of cells may be used. The cells 130 are grouped together to form cell groups 132 (only one cell group 132 identified in FIG. 6B). Individual cells 130 within the cell groups 132 are connected in parallel to each other. Thus, a single cell group 132, when balanced, has a voltage equivalent to any one of the individual cells 130 within it. The cell groups 132 are connected in series to one another, within the battery module 120, to form a module circuit. The module circuit has the two terminals 134 electrically connected thereto. In the present embodiment, the module circuit has a voltage between the terminals 134 that corresponds to the sum of the voltage of each of the cell groups 132 within it. The number of cell groups 132 connected in series is selected so that the voltage is below a pre-determined voltage, regardless of the charge level of the cells 130 within it. Cell voltage is dependent on charge level, with maximal voltage being provided when the cell is fully charged, and decreasing with the charge level of the cells 130. For the purposes of the present description, it is assumed that the cells 130 are fully charged.

Thus, being that the voltage of the battery modules 120 is below the pre-determined voltage, the module circuit has a low voltage and by extension the battery modules 120 are low-voltage units. It is contemplated that the cells 130 could be connected differently which could result in a different module circuit voltage. For the purposes of the present description, the pre-determined voltage is 60V. More specifically, the module circuit formed by the connection of cell groups 132 has a voltage of about 58.8V, and may therefore be referred to as a low-voltage circuit (i.e., each battery module unit 120 has a voltage of about 58.8V). It is contemplated that the pre-determined voltage could be 70V or 50V. Unless otherwise specified, all voltages mentioned herein refer to DC (direct current) supply. It is contemplated that in other embodiments, the pre-determined voltage could be 30V (or other voltage) with alternating current (AC) supply. It is also contemplated that some battery modules 120 may be different from one another. For example, the battery module 120a may have a total voltage of about 58.8V, and the battery module 120b may have a total voltage of about 40V.

Still referring to FIG. 6B, the holding matrix 135 holds the cells 130. In the illustrated embodiment, the holding matrix 135 defines openings 136 in which the cells 130 are received. The holding matrix 135 is sized to fit within the bottom and upper covers 112, 114. The holding matrix 135 is connected to a housing 138. More specifically, the holding matrix 135 is selectively fastened to the housing 138. It is contemplated that the holding matrix 135 and the housings 138 could be connected together in a variety of different ways that allow for the selective attachment/detachment of the holding matrix 135 and the housing 138, such as, for example, tabs, latches, spring fasteners, etc. The housing 138 will be described in greater detail below.

Each battery module 120 also has the two terminals 134. The terminals 134 are electrically connected to the cells 130. One of the terminals 134 is disposed on a left side of the holding matrix 135, and the other terminal 134 is disposed on a right side of the holding matrix 135. It is contemplated that the terminals 134 could be positioned differently. For example, the terminals 134 could be disposed on the same lateral side and be vertically offset from one another. The terminals 134 of the battery modules 120 are also referred to as interconnection terminals. Each terminal 134 has a conductor bar 137 that substantially extends along a height of the holding matrix 135.

In the illustrated embodiment, the battery pack 100 has four housings 138 (see FIG. 6A). It is contemplated that the number of housings 138 may vary from one embodiment to another. The frontmost housing 138 is connected to the connection unit 122 and to the battery module 120a. Each of the other three housings 138 is connected to two battery modules 120. Each housing 138 includes a cold plate 139 disposed at the middle thereof. Thus, the cold plate 139 of the frontmost housing 138 is disposed between the connection unit 122 and the battery module 120a, whereas the cold plate 139 of the other three housings 138 is disposed between corresponding two battery modules 120. In the present embodiment, the cold plate 139 is in engagement with the cells 130.

Referring back to FIGS. 2A, 2B, 3 and 4, the connection unit 122 is disposed at an end of the battery pack 100. More specifically, with reference to FIG. 6A, the connection unit 122 is disposed at a front end of the battery pack 100 such that the connection unit 122 is adjacent to the battery module 120a. It is contemplated that the connection unit 122 may be disposed elsewhere. For example, the connection unit 122 may be disposed at a rear end of the battery pack 100, adjacent to the battery module 120g.

The connection unit 122 has a connection interface 140 and a connection holder 142. The connection interface 140 is connected to and supported by the connection holder 142. The connection interface 140 is provided with connection ports to connect to a variety of components of the electric vehicle including, but not limited to, a charger, a power inverter, and a DC-DC converter. When the battery pack 100 is assembled, the connection interface 140 extends through the front aperture 118 of the upper cover 114. The connection holder 142 is shaped similarly to the holding matrix 135, and is connected to the frontmost housing 138. Additionally, the connection holder 142 supports a plurality of conductors 145 (seen in FIG. 2B).

The connection unit 122 also has a left interlocker 150 and a right interlocker 152. In the present embodiment, the left and right interlockers 150, 152 are left and right recesses 150, 152 respectively, and will henceforth be referred to as such. A tab 151 extends longitudinally within the recess 150, and a tab 153 extends longitudinally within the recess 152. The tabs 151, 153 are connected to one another by an intermediate portion 155 extending generally laterally. The tabs 151, 153 and the intermediate portion 155 are monolithic. It is contemplated that the tabs 151, 153 could be separate members. It is contemplated that in some embodiments, the tabs 151, 153 could be omitted. As will be described below, the left and right recesses 150, 152 and the left and right tabs 151, 153 are part of the retention assembly 127, and are configured to engage with the left and right conductor assemblies 124, 126 to prevent disconnection of the connection unit 122 from the battery modules 120.

The connection unit 122 also has two terminals 154 that are electrically connected to the connection interface 140, and that may be referred to as output terminals 154. One of the terminals 154 is disposed on a left side of the connection holder 142, and the other terminal 154 is disposed on a right side of the connection holder 142. When the battery pack 100 is assembled, the terminals 154 of the connection unit 122 are vertically lower than the terminals 134 of the battery modules 120. It is contemplated that the relative positioning between the terminals 134 and the output terminals 154 may vary from one embodiment to another. For example, the terminals 154 may be vertically higher than or vertically aligned with the terminals 134. It is contemplated that in some embodiments, the connection unit 122 could be omitted.

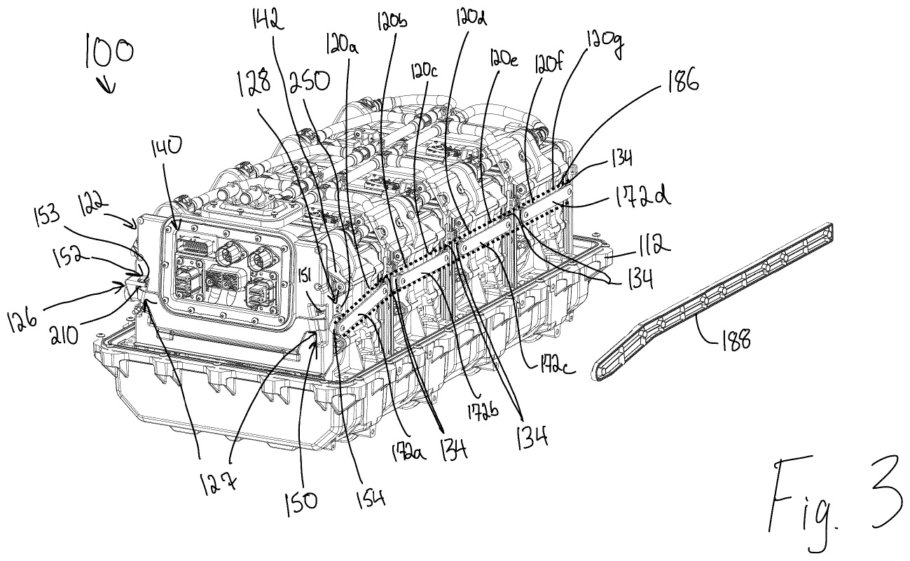

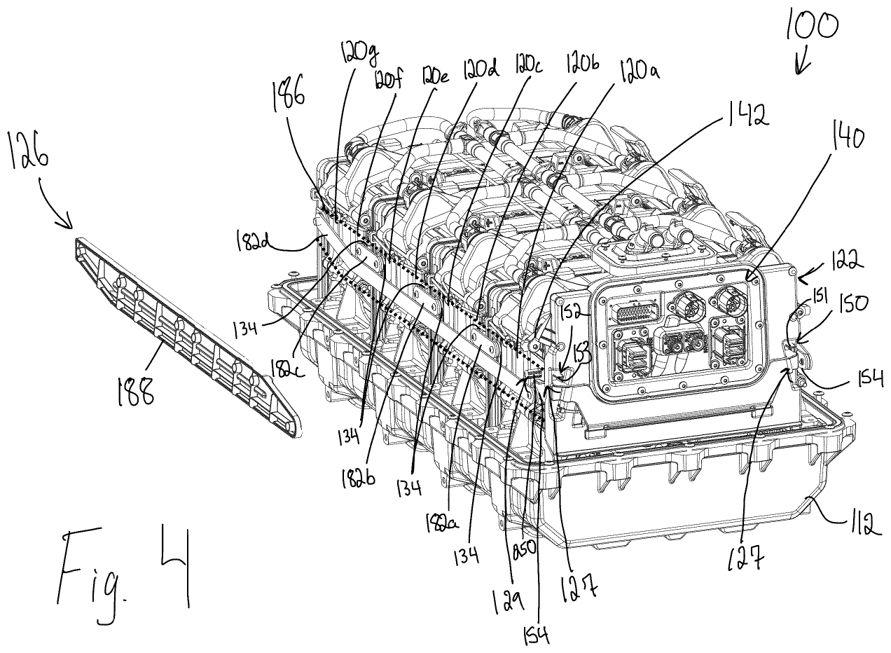

Referring to FIGS. 2A, 2B, 3, 4, 5A and 5B, the left and right conductor assemblies 124, 126 will now be described in greater detail. The left conductor assembly 124, which is disposed on the left side of the battery pack 100, includes a cover 170 (part of which is shown in dotted lines in FIG. 3) and conductors 172a, 172b, 172c, 172d (collectively referred to as conductors 172). As will be described below, the conductors 172 are received in the cover 170. Likewise, the right conductor assembly 126, which is disposed on the right side of the battery pack 100, includes a cover 180 (also part of which is shown in dotted lines in FIG. 4) and conductors 182a, 182b, 182c, 182d (collectively referred to as busbars 182). The conductors 182 are received in the cover 180. The conductors 172, 182 are busbars 172, 182, such that the left and right conductor assemblies 124, 126 are busbar assemblies 124, 126. It is contemplated that in other embodiments, the number of busbars 172, 182 may vary.

As will be described below, the busbar assemblies 124, 126 are selectively connected to the battery modules 120 such that the connected battery modules 120 are connected in series, forming a battery pack circuit. As with the module circuit, the voltage of the battery pack circuit corresponds to the sum of the voltage of the module circuits which are connected in series within it. Thus, the voltage between the output terminals 154 of the battery pack circuit is greater than the pre-determined voltage. In the present embodiment, the voltage of the connected battery modules 120 forming the battery pack circuit is about 411.6V between the output terminals 154. It can be said that when the battery modules 120 are connected to one another via the busbar assemblies 124, 126, a high voltage is present between the output terminals 154 of the battery pack 100, as well as between certain pairs of interconnection terminals 134.

The busbars 172a, 172b, 172c, 172d are generally thin plates that are shaped similarly to one another, with the exception that the busbar 172a is longer than the busbars 172b, 172c, 172d. The busbars 172b, 172c, 172d are sized to extend from one terminal 134 of one of the battery modules 120 to another terminal 134 of an adjacent battery module 120, whereas the busbar 172a is sized to extend between the terminal 134 of the connection unit 122 and the terminal 154 of the battery module 120a. Thus, the additional length of the busbar 172a is to accommodate for the vertical offset between the terminal 134 of the connection unit 122 and the terminal 154 of the battery module 120a.

The busbars 182a, 182b and 182c are also generally thin plates that are shaped similarly to one another. The busbars 182a, 182b, 182c are sized to extend from one terminal 134 of one of the battery modules 120 to another terminal 134 of an adjacent battery module 120. The busbar 182d is also a thin plate, but is longer than the busbars 182a, 182b, 182c. The busbar 182d is sized to extend from the front end of the battery pack 100 to a rear end of the battery pack 100. More specifically, the busbar 182d is sized and shaped to extend from the terminal 154 of the connection unit 122 to the terminal 134 of the battery module 120g. The busbar 182d is angled to accommodate for the vertical offset between the terminals 134, 154.

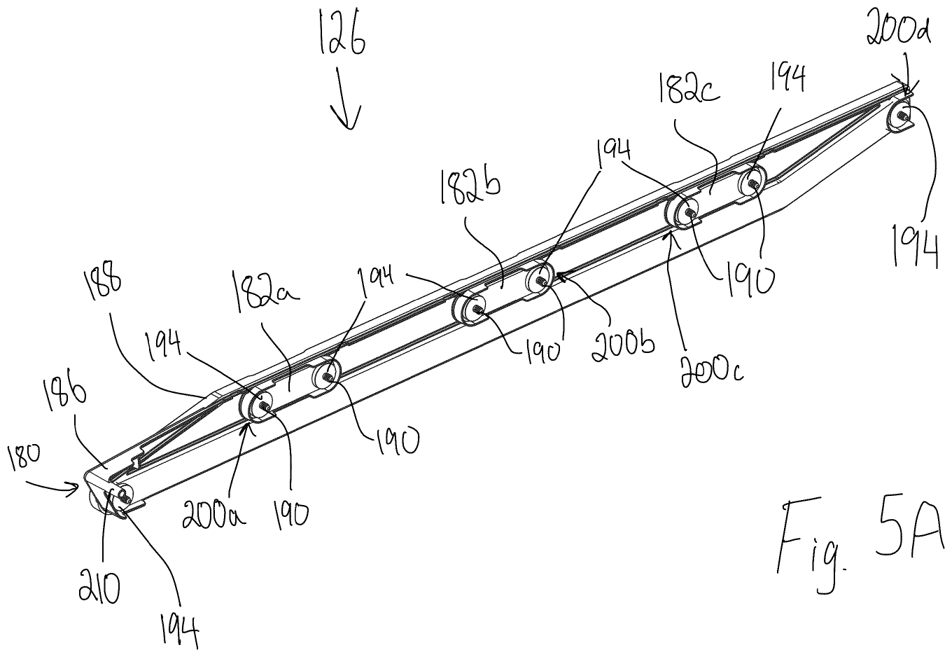

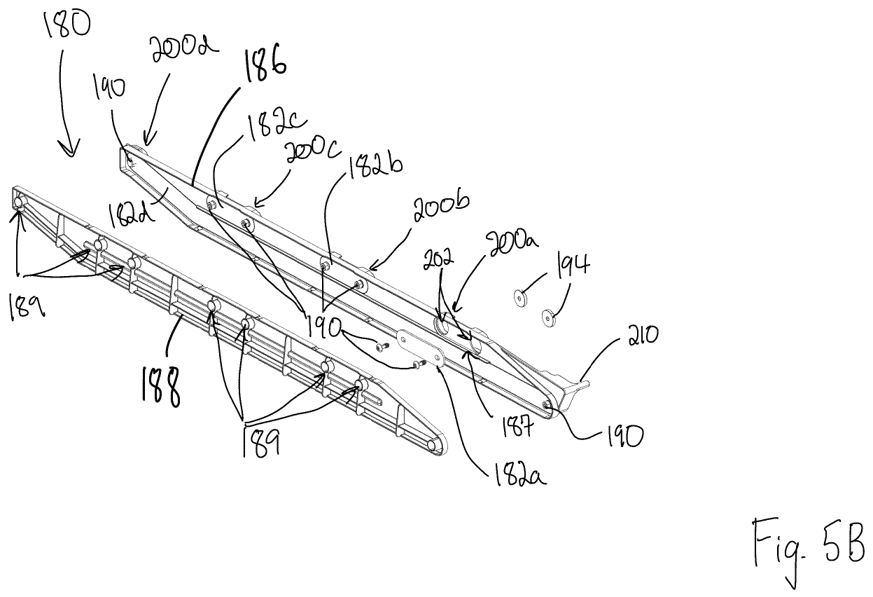

As the busbars 172, 182 are generally similar, only the busbar 182a will be described in detail herewith with reference to FIGS. 5A and 5B, in which features of the busbars 182b, 182c, 182d similar to features of the busbar 182a have been labeled with the same reference numerals.

The busbar 182a defines a front aperture at a front end thereof, and a rear aperture at a rear end thereof. Fasteners 190 are received in the front and rear apertures. The fasteners 190 mechanically fasten the busbar 182 to respective terminals 134. Additionally, metal rings 194 are also connected to the fasteners 190. As will be described in greater detail below, the metal rings 194 accommodate for part of the thickness of the cover 180. It is contemplated that in some embodiments, the metal rings 194 may be omitted.

Still referring to FIGS. 2A, 2B, 3, 4, 5A and 5B, the covers 170, 180 will now be described in greater detail. The cover 170 is shaped to connect with and fully cover the busbars 172, whereas the cover 180 is shaped to connect with and fully cover the busbars 182. As the busbars 172 vary in shape from the busbars 182, the cover 170 is shaped differently from the cover 180. Aside from their shapes, the covers 170, 180 are generally similar to one another. Thus, only the cover 180 will be described herewith. Features of the cover 170 similar to features of the cover 180 have been labeled with the same reference numerals.

Referring to FIGS. 5A and 5B, the cover 180 is elongated to reach from the front end of the battery pack 100 to the rear end of the battery pack 100. The cover 180 is made of an inner cover portion 186 and an outer cover portion 188. It is contemplated that the cover 180 could be made of more or fewer portions. The inner cover portion 186 and the outer cover portion 188 are selectively connected to one another. More specifically, in the present embodiment, the inner and outer cover portions 186, 188 are configured to snap together. The inner and outer cover portions 186, 188 could be connected together in a variety of different ways that allow for the selective attachment/detachment thereof, such as, for example, tabs, latches, spring fasteners, etc.

The inner cover portion 186 defines, on the laterally outer surface (i.e., the surface facing the outer cover portion 188), four recesses 187 (only one recess 187 is shown in FIG. 5B). Each recess 187 receives a corresponding one of the busbars 182 therein, which limits relative movement between the busbars 182 and the cover 180. It is contemplated that in other embodiments, the inner cover portion 186 could have other positioners instead of, or in addition to, the recesses 187. For example, in some embodiments, the busbars 182 could be positioned in and/or generally fixed to the inner cover portion 186 via abutting members like latches and/or via an adhesive. It is understood that the inner cover portion 186 defines four recesses 187, one of which is sized and shaped to accommodate for the busbar 182d. Within each recess 187, at each longitudinal end thereof, the inner cover portion 186 defines apertures 202 (only two apertures 202 shown in FIG. 5B). Each aperture 202 is configured to receive a fastener 190 and a metal ring 194 therein.

The inner cover portion 186 has, on the laterally inner surface, casing 200a, 200b, 200c, 200d. The casings 200a, 200b, 200c are similar to one another, and are aligned with corresponding recesses 187, and the casing 200d is disposed at a rear end of the inner cover portion 186. As will be described below, the casings 200a, 200b, 200c, 200d are configured to encase corresponding terminals 134, 154, and insulate the connection between the busbars 182 and the terminals 134, 154 while also assisting in positioning the cover 180 relative to the battery modules 120. Thus, if the cover 180 is removed from the battery modules 120 and the connection unit 122 by moving the cover 180 away therefrom, the busbars 182, 182b, 182c, 182d are disconnected from the terminals 134, 154.

The inner cover portion 186 further has, extending from the laterally inner surface, an interlocker 210, which is part of the retention assembly 127. The interlocker 210 is a protrusion 210, and will henceforth be referred to as such. The protrusion 210 extends generally laterally inward (like the casings 200a, 200b, 200c, 200d). As will be described below, the protrusion 210 of the cover 180 is configured to engage with the right interlocker 152 of the connection unit 122. The cover 170 has a corresponding interlocker 210 configured to engage with the left interlocker 150 of the connection unit 122. It is contemplated that the configurations of the interlockers 150, 210 may vary. For example, the interlocker 150 could be a recess, an aperture or a hook complementary to the interlocker 210. The engagement between the interlockers 150, 210 will be described in greater detail below.

The outer cover portion 188 is sized and shaped to cover the busbars 182 when the outer cover portion 188 is connected to the inner cover portion 186. The outer cover portion 188 defines apertures 189 for receiving the fasteners 190 therein.

The inner and outer cover portions 186, 188 are made of an electrically non-conductive material. In the present embodiment, the inner and outer cover portions 186, 188 are made of plastic, but it is contemplated that another non-conductive material, such as rubber, could be used.

When fully assembled, the busbars 182 are received in the recesses 187 of the inner cover portion 186, and the outer cover portion 188 is connected to the inner cover portion 186 such that the busbars 182 are sandwiched between the inner and outer cover portions 186, 188. The metal rings 194 are received in the apertures 202. The metal rings 194 accommodate for the thickness of the inner cover portion 186 to ensure good connection between the busbars 182 and the terminals 134, 154 when the busbar assembly 126 is connected to the battery modules 120 and to the connection unit 122 (i.e., the metal rings 194 bridge a distance that is present between the busbars 182 and the terminals 134, 154 due to the thickness of the inner cover portion 186).

When the busbar assemblies 124, 126 are connected to the battery modules 120 and the connection unit 122, the busbars 172, 182 are electrically connected to the battery modules 120 and to the connection unit 122, thereby completing the high-voltage battery pack circuit, resulting in high voltage being present between multiple conductors throughout the now completed battery pack circuit. The covers 170, 180, by covering the busbars 172, 182 and by being made of an electrically non-conductive material, assist in limiting likelihood of coming into contact with conductors which may be at a high voltage. It will be appreciated that due to the configuration of the busbar assemblies 124, 126, when connecting the busbar assemblies 124, 126 to the battery modules 120, the busbars 172 are all electrically connected to respective battery modules 120 at the same time, and the busbars 182 are also electrically connected to respective battery modules 120 at the same time. This limits the likelihood of coming into contact with an exposed conductor energized at a high voltage, while also accelerating and simplifying the connection process between the busbar assemblies 124, 126 and the battery modules 120 and the connection unit 122.

Also, disconnecting the busbars 172, 182 at once ensures that the voltage of any exposed conductors in the battery pack 100 goes from beyond the pre-determined voltage to below the pre-determined voltage at once, in a single operation, thereby reducing the steps that need to be performed in the presence of exposed high-voltage conductors.

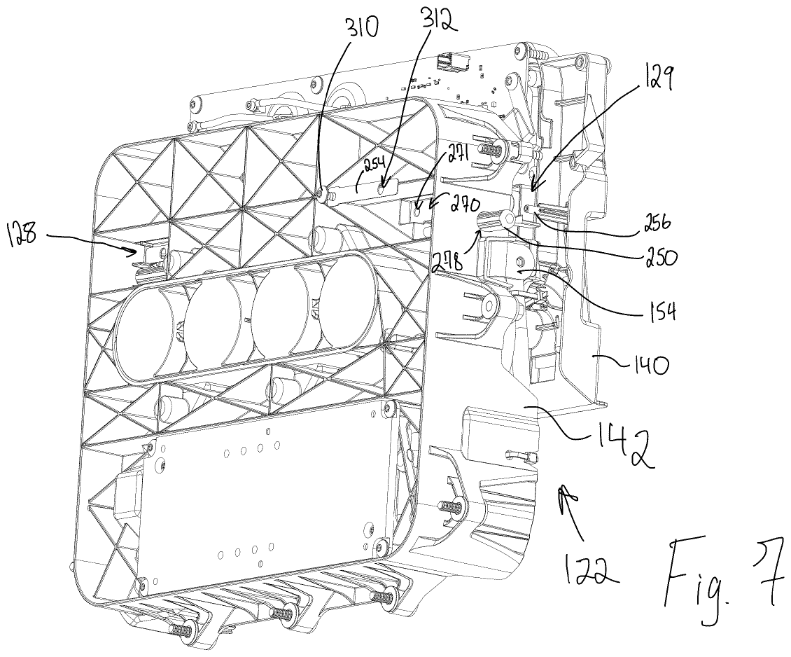

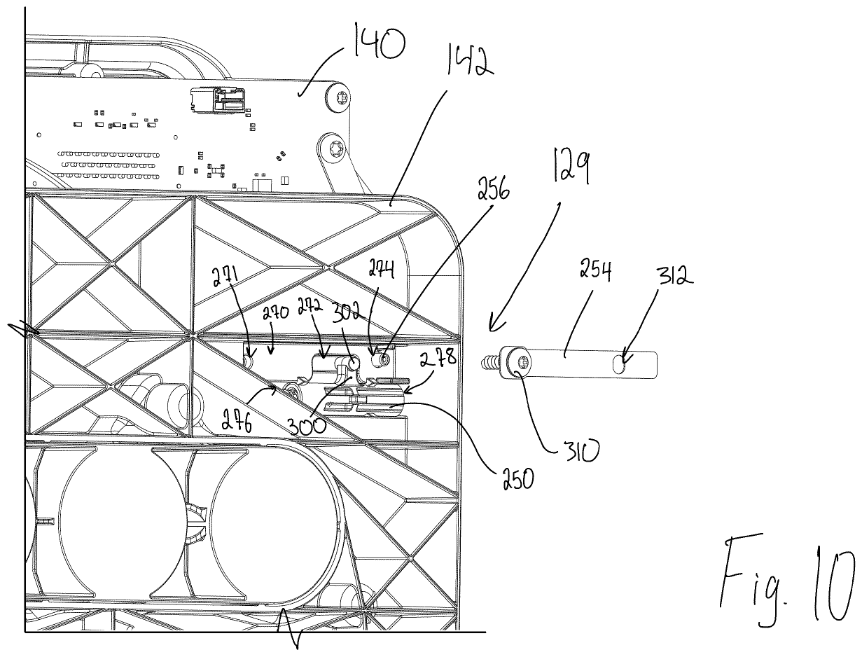

Referring now to FIGS. 7 to 10, the left and right stopping assemblies 128, 129 will be described in greater detail. The left stopping assembly 128 is disposed on a left side of the battery pack 100, and is configured to engage with the left busbar assembly 124. The right stopping assembly 129 is disposed on a right side of the battery pack 100, and is configured to engage with the right busbar assembly 126. Given that the left and right stopping assemblies 128, 129 are similar, only the right stopping assembly 129 will be described in detail herewith.

The stopping assembly 129 includes a stopper 250, a biasing member 252, a locking member 254 and an unlocking member 256. As will be described in greater detail below, in certain situations, the stopper 250 can stop the connection of the busbar assembly 126 to the battery modules 120 and/or to the connection unit 122.

In the present embodiment, the stopping assembly 129 is disposed on the connection unit 122. Part of the stopping assembly 129 is disposed on the connection interface 140 and part of the stopping assembly 129 is disposed on the connection holder 142. More specifically, the unlocking member 256 is disposed on the connection interface 140, whereas the stopper 250, the biasing member 252 and the locking member 254 are disposed on the connection holder 142. It is contemplated that in other embodiments, the stopping assembly 129 could be disposed on any other two adjacent modules, for example, on the battery modules 120b, 120c.

To accommodate for the stopping assembly 129, the connection holder 142 defines on a rear side thereof, a recess 270. Within the recess 270, there is defined a threaded aperture 271, a slot 272 and a through aperture 274. The threaded aperture 271 is positioned laterally opposite the through aperture 274. Vertically below, and adjacent to, the recess 270, there is defined a channel 276. Additionally, the connection holder 142 defines on a right side thereof, a side aperture 278 that is aligned with the channel 276.

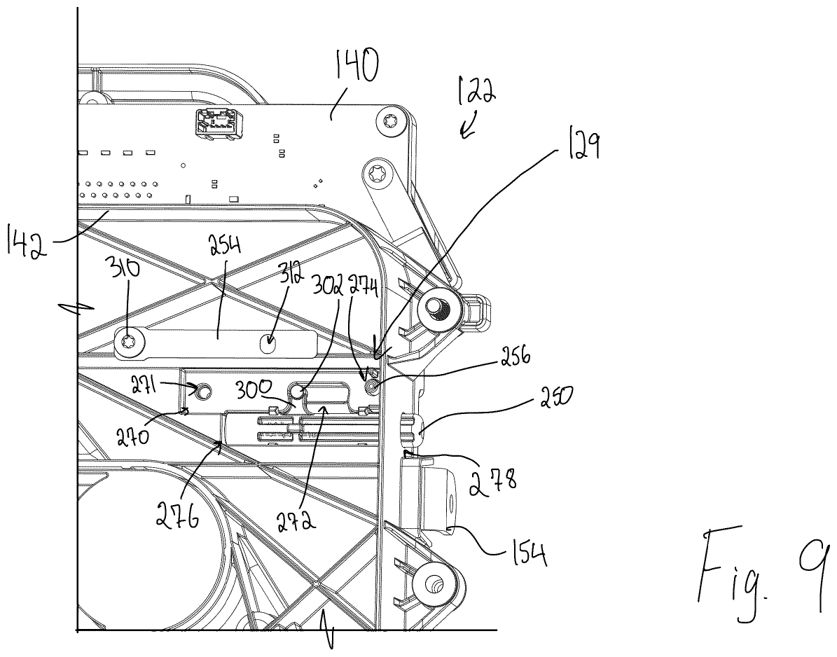

The stopper 250 is received in the channel 276, and extends through the side aperture 278. The stopper 250 has a flange 300 that extends generally vertically upward. The stopper 250, the flange 300, the channel 276 and the slot 272 are configured such that the flange 300 is partially received in the slot 272. The flange 300 has a protrusion 302 that extends generally longitudinally, and as will be described below, the protrusion 302 is configured to engage with the locking member 254. The stopper 250 is moveable between a retracted position, shown in FIG. 9 (stopper 250 of the stopping assembly 128 is also shown in the retracted position in FIG. 3), and an extended position, shown in FIGS. 4, 7, 8A and 10. When the stopper 250 is in the extended position, the stopper 250 extends further outward from the side aperture 278 than when the stopper 250 is in the retracted position. As the stopper 250 slides in the channel 276 between the extended and retracted positions, the protrusion 302 slides in the slot 272.

The biasing member 252 is also received in the channel 276. The biasing member 252 is connected to the connection unit 122 and to the stopper 250. More specifically, one end of the biasing member 252 is connected to a rear wall of the connection holder 142, where the rear wall defines an end of the channel 276. The other end of the biasing member 252 is connected to the stopper 250. The biasing member 252 is a spring, but it is contemplated that in other embodiments, the biasing member 252 could be another resilient member, such as a polymeric member. The biasing member 252 biases the stopper 250 toward the extended position.

The locking member 254 is received in the recess 270. The locking member 254 is connected to the connection unit 122 via a fastener 310 that is received in the threaded aperture 271. The locking member 254 is a locking strip that is sized to extend over the through aperture 274. The locking member 254 is at least partially flexible. In the present embodiment, the flexibility of the locking member 254 is in part conferred by the locking member 254 being made of a metallic material. It is contemplated that the locking member 254 could be made of other material such as plastic. The locking member 254 defines an aperture 312 that is configured to, as will be described below, receive the protrusion 302 of the stopper 250 in certain situations.

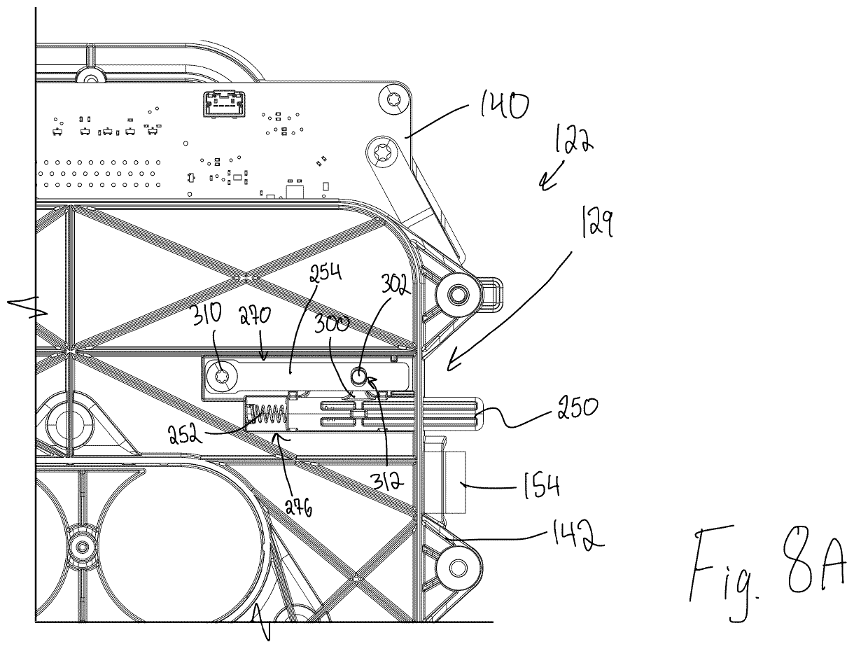

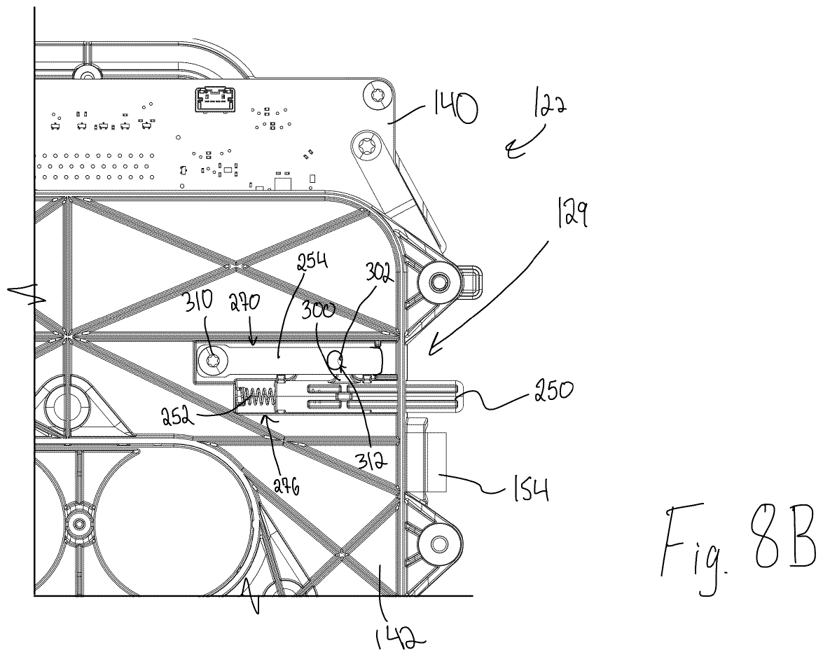

The locking member 254 is moveable between an unlocked position (FIG. 8B) and a locked position (FIG. 8A). In the present embodiment, moving the locking member 254 between the locked and unlocked positions implies deformation, specifically bending, of the locking member 254. However, it is contemplated that the locking member 254 could be configured to pivot or linearly move between locked and unlocked positions.

The unlocking member 256 extends longitudinally rearward from a rear surface of the connection interface 140. The unlocking member 256 is positioned and sized such that when the connection interface 140 is connected to the connection holder 142, the unlocking member 256 partially extends in the through aperture 274, and engages the locking member 254, causing the locking member 254 to move to the unlocked position.

As best seen in FIGS. 4 and 8A, the stopping assembly 129 is configured to prevent connection of the busbar assembly 126 to the battery modules 120 and to the connection unit 122, more specifically, to prevent connection between the busbars 182 and the terminals 134, 154, when the connection interface 140 is spaced from (i.e., not connected to) the connection holder 142.

In more detail, when the busbar assembly 126 is not connected to the connection unit 122 and the battery modules 120a, the stopper 250 is in the extended position due to the biasing member 252. Additionally, when the connection interface 140 is spaced from the connection holder 142, the unlocking member 256 is not received in the through aperture 274, such that the locking member 254 is in the locked position.

When the stopper 250 is in the extended position, and the locking member 254 is in the locked position, the protrusion 302 is received in the aperture 312, which locks the stopper 250 in the extended position (i.e., movement of the stopper 250 is restricted). Thus, if there is an attempt to connect the busbar assembly 126, the stopper 250 abuts against the cover 180, which prevents the cover 180 from reaching a final position in which the busbars 182 are connected to the terminals 134, 154. Thus, mounting of the busbar assembly 126 is not possible when the connection interface 140 is not completely seated on the connection holder 142.

Referring to FIG. 9, the stopping assembly 129 is configured to enable connection of the busbar assembly 126 to the battery modules 120 and the connection unit 122 only when the connection interface 140 is connected to the connection holder 142. Generally, the connection interface 140 would be connected to the connection holder 142 as the final step before connecting the left and right busbar assemblies 124, 126. As a result, the voltage between any two points in the battery pack 100 circuit is configured to only be above the pre-determined voltage after all the battery modules 120 and the connection unit 122 have been connected. This can limit the steps required to assemble the battery pack 100 while high voltage is present.

In more detail, when the connection interface 140 is connected to the connection holder 142, the unlocking member 256 extends through the through aperture 274, and engages the locking member 254. The engagement between the unlocking member 256 and the locking member 254 causes the locking member 254 to bend, thereby moving to the unlocked position. When the locking member 254 is in the unlocked position, the protrusion 302 is no longer received in the aperture 312, such that the stopper 250 is no longer locked in the extended position (i.e., the stopper 250 can move between the retracted and extended positions). Thus, if there is an attempt to connect the busbar assembly 126, after connecting the connection interface 140 to the connection holder 142, the cover 180 abuts against the stopper 250, and causes the stopper 250 to move to the retracted position, and the cover 180 ultimately reaches its final position, in which the busbars 182 are electrically connected to the terminals 134, 154. The busbars 182 can then be fastened to the terminals 134, 154 via the fasteners 190, 192.

Once the busbar assembly 126 is connected to the battery modules 120 and the connection unit 122, the protrusion 210 of the cover 180 is received in the recess 150. The protrusion 210 abuts against the tab 151 of the intermediate portion 155. The interlock between the protrusion 210, the tab 151 and the recess 150 prevents disconnection of the connection unit 122, as well as the connection interface 140 from the battery modules 120 while the busbar assembly 126 is connected to the battery modules 120 and the connection unit 122. Thus, to disassemble the battery pack 100, the busbar assemblies 124, 126 have to first be removed by moving them laterally away from the battery modules 120 and the connection unit 122, which consequently removes the presence of exposed high-voltage conductors on the battery pack, resulting in the battery pack circuit being broken up into multiple low-voltage units.

A description of a method for assembling the battery pack 100 will now be provided.

The method begins by positioning the battery modules 120 in the bottom cover 112. It will be appreciated that at this stage, some of the conductors which, during the course of normal battery pack use, may have a high voltage, are exposed and accessible. However, the busbar assemblies 124, 126 are not, and cannot be, connected to the battery modules 120, such that there is no voltage above the pre-determined voltage present anywhere on the battery pack. The busbar assemblies 124, 126 cannot be connected at this stage, because the connection interface 140 is not connected to the connection holder 142, which results in the stoppers 250 of the stopping assemblies 128, 129 being locked, by respective locking members 254, in the extended position.

The method then continues by connecting the connection holder 142 to the frontmost housing 138 (i.e., the connection holder 142 is connected to the battery module 120a).

The method then continues by connecting the connection interface 140 to the connection holder 142. Connecting the connection interface 140 to the connection holder 142 covers exposed conductors 145 (shown in FIG. 2B) which will eventually be energized at a high voltage. Connecting the connection interface 140 to the connection holder 142 also moves the locking members 254 of the stopping assemblies 128, 129 to their unlocked positions. As described above, each unlocking member 256 of the stopping assemblies 128, 129 moves the respective locking member 254 to the unlocked position, which enables each of the stoppers 250 to move between the retracted and extended positions.

The method then continues by connecting the busbar assemblies 124, 126 to the battery modules 120 and to the connection unit 122. To do so, the busbar assembly 124 is configured to install the busbars 172 on the battery modules 120 and the connection unit 122 together with the cover 170, such that the cover 170 moves the stopper 250 of the stopping assembly 128 to the retracted position and the busbars 172 are electrically connected to respective terminals 134, 154. The busbars 172 are then fastened to respective terminals 134, 154 via the fasteners 190, 192 to secure the connection between the busbars 172 and respective terminals 134, 154. Once connected, the cover 170 fully covers the busbars 172 and the respective terminals 134, 154, which may be energized at a high voltage, making them no longer exposed. Similarly, the busbar assembly 126 is configured to install the busbars 182 on the battery modules 120 and the connection unit 122 together with the cover 180, such that the cover 180 moves the stopper 250 of the stopping assembly 129 to the retracted position and the busbars 182 are electrically connected to respective terminals 134, 154. The busbars 182 are then fastened to respective terminals 134, 154 via the fasteners 190, 192 to secure the connection between the busbars 182 and respective terminals 134, 154. Once connected, the cover 180 fully covers the busbars 182 and the respective terminals 134, 154, which may be energized at a high voltage. It is contemplated that the busbar assembly 126 could be connected to the battery modules 120 and the connection unit 122 before the busbar assembly 124.

At this stage, after connecting the busbar assemblies 124, 126 to the battery modules 120 and the connection unit 122, the voltage between the terminals 154, which are now covered by the covers 170, 180, as well as between other conductors, which are also covered by the covers 170, 180, is above the pre-determined voltage.

The method then continues by fastening the upper cover 114 to the bottom cover 112.

A description of a method for disassembling the battery pack 100 will now be provided.

The method begins by unfastening the upper cover 114 from the bottom cover 112.

At this stage, the battery modules 120 and the connection unit 122 cannot be disconnected from one another, because of the interlock between the interlocks 150, 210. Thus, in order to disconnect the battery modules 120 and/or the connection unit 122 from one another, the busbar assemblies 124, 126 must first be disconnected, which breaks down the single high-voltage battery pack circuit into multiple low-voltage units, removing the presence of a high voltage on conductors which would otherwise be exposed once the connection unit 122 is removed.

The method then continues by unfastening the fasteners 190, 192, and then moving the busbar covers 170, 180 away from the battery modules 120. Due to the connection of the busbars 172 with the cover 170, and due to the connection of the busbars 182 with the cover 180, when the covers 170, 180 are moved away from the battery modules 120, the busbars 172, 182 move away from the battery modules 120 together with the covers 170, 180. Moving the busbars 172, 182 away from the terminals 134, 154 electrically disconnects the battery modules 120 and the connection unit 122 from one another. As a result, the remaining battery pack components are individual low-voltage units, there is no voltage beyond the pre-determined voltage.

It will be appreciated that moving the covers 170, 180 laterally away from the connection unit 122 results in the interlockers 150, 210 being disengaged from one another, such that the connection interface 140 can be disconnected from the connection holder 142, which are below the pre-determined voltage, because the busbars 172, 182 between the modules have been removed, leaving only the low-voltage module circuits. The other battery modules 120 can also be unfastened from one another, and then removed from the bottom cover 112.

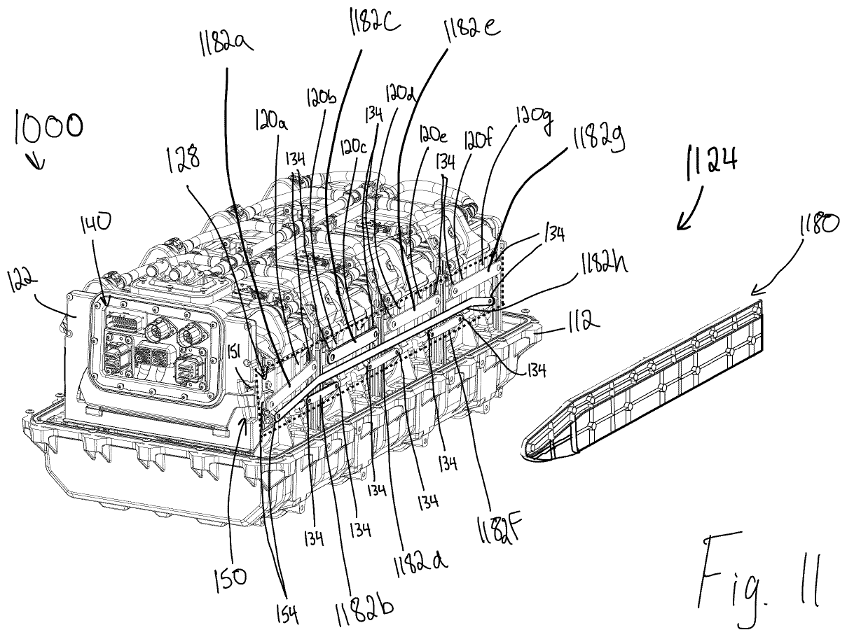

Referring to FIG. 11, a battery pack 1000 according to an alternative embodiment of the present technology is shown. Features of the battery pack 1000 similar to those of the battery pack 100 have been labeled with the same reference numerals, and will not be re-described in detail herewith.

In this embodiment, the terminals 134 of the battery modules 120 and the terminals 154 of the connection unit 122 are all disposed on the same lateral side. In this embodiment, the terminals 134, 154 are disposed on the left side of the battery modules 120 and the connection unit 122. It is contemplated that the terminals 134, 154 could all be disposed on the right side of the battery modules 120 and the connection unit 122.

Additionally, the battery pack 1000, unlike the battery pack 100, only has a single conductor assembly 1124. The conductor assembly 1124 is a busbar assembly 1124. The busbar assembly 1124 includes a cover 1180 (part of which is shown by dotted lines in FIG. 11) and busbars 1182a, 1182b, 1182c, 1182d, 1182e, 1182f, 1182g, 1182h (collectively referred to as busbars 1182). The busbars 1180 are encased in the cover 1180, such that when the cover 1180 is moved away from the battery modules 120, the busbars 1180 move away from the battery modules 120 together with the cover 1180.

The cover 1180 is sized and shaped to entirely cover the busbars 1182 and the terminals 134, 154. The cover 1180 is similar to the covers 170, 180, and will therefore not be re-described herewith.

The busbars 1182 are also similar to the busbars 172, 182 and will therefore also not be re-described in detail herewith.

In this embodiment, installing the busbar assembly 1124 on the battery modules 120 and the connection unit 122 results in the voltage at the output terminals of the battery pack 1000 going from below the pre-determined voltage to above the pre-determined voltage in the single step of installing the busbar assembly 1124 onto the battery pack terminals. The fact that the busbar assembly 1124 is installed in a single step, in which exposed conductors are covered limits the number of steps required to assemble the battery pack 1000 which would otherwise be performed while the battery pack 1000 has exposed conductors energized at a high voltage.

Similarly, removing the busbar assembly 1124 from the battery modules 120 and the connection unit 122 results in the voltage at the output terminals of the battery pack 1000 going from above the pre-determined voltage to below the pre-determined voltage in a single step, which limits steps required to disassemble the battery pack 1000 while the battery pack 1000 presents exposed conductors which are energized at a high voltage.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. A battery pack comprising:
a first low-voltage unit;
a second low-voltage unit;
a third low-voltage unit;
a plurality of terminals connected to the first low-voltage unit, to the second low-voltage unit, and to the third low-voltage unit, the plurality of terminals including:
two output terminals; and
a first interconnection terminal connected to the first low-voltage unit;
a second interconnection terminal connected to the second low-voltage unit;
a third interconnection terminal connected to the second low-voltage unit; and
a fourth interconnection terminal connected to the third low-voltage unit,
a conductor assembly comprising:
a first conductor selectively electrically connected to the first interconnection terminal and to the second interconnection terminal;
a second conductor selectively electrically connected to the third interconnection terminal and the fourth interconnection terminal; and
with the first conductor electrically connected to the first interconnection terminal and to the second interconnection terminal, and the second conductor electrically connected to the third interconnection terminal and the fourth interconnection terminal, a voltage greater than a pre-determined voltage is present between two terminals of the plurality of terminals;
a cover connected to the first conductor and to the second conductor, the cover being made of electrically non-conductive material, and the cover covering:
the first conductor;
the second conductor;
the first interconnection terminal;
the second interconnection terminal;
the third interconnection terminal; and
the fourth interconnection terminal,
the conductor assembly being configured to remove the first conductor and the second conductor together with the cover, thereby;
electrically disconnecting the first conductor from the first interconnection terminal and from the second interconnection terminal;
electrically disconnecting the second conductor from the third interconnection terminal and from the fourth interconnection terminal; and
providing access to the first interconnection terminal, to the second interconnection terminal, to the third interconnection terminal and to the fourth interconnection terminal;
the conductor assembly being configured to install the first conductor and the second conductor together with the cover, thereby:
electrically connecting the first conductor to the first interconnection terminal and to the second interconnection terminal;
electrically connecting the second conductor to the third interconnection terminal and to the fourth interconnection terminal; and
covering the first interconnection terminal, the second interconnection terminal, the third interconnection terminal and the fourth interconnection terminal,
in response to the first conductor being disconnected from the first interconnection terminal and from the second interconnection terminal and the second conductor being disconnected from the third interconnection terminal and from the fourth interconnection terminal, the voltage between any two terminals of the plurality of terminals is less than or equal to the pre-determined voltage.

2. The battery pack of claim 1, wherein:
the first conductor is selectively mechanically fastened to the first interconnection terminal and to the second interconnection terminal; and
the second conductor is selectively mechanically fastened to the third interconnection terminal and to the fourth interconnection terminal.

3. The battery pack of claim 1, wherein the first conductor and the second conductor are encased in the cover.

4. The battery pack of claim 1, wherein the plurality of terminals further comprises two other terminals, and the battery pack further comprises a connection unit having the two other terminals, such that the connection unit is selectively electrically connected to the first low-voltage unit, to the second low-voltage unit, and to the third low-voltage unit.

5. The battery pack of claim 4, wherein the connection unit includes at least one of a charger, an inverter, or a DC-DC converter.

6. The battery pack of claim 4, wherein the first low-voltage unit, the second low-voltage unit, the third low-voltage unit and the connection unit are mechanically connected to one another.

7. The battery pack of claim 1, wherein the pre-determined voltage is one of: 50 volts or 60 volts.

8. The battery pack of claim 1, wherein at least one of:
the first conductor is a first busbar, and the second conductor is a second busbar; or
the first low-voltage unit is a first battery module, the second low-voltage unit is a second battery module and the third low-voltage unit is a third battery module.

9. The battery pack of claim 1, wherein at least one of the first low-voltage unit, the second low-voltage unit, or the third low-voltage unit includes at least two cells of lithium-ion type.

10. The battery pack of claim 1, wherein the cover further covers the two output terminals.

11. A battery pack comprising:
a first low-voltage unit;
a second low-voltage unit;
a third low-voltage unit;
a plurality of terminals connected to the first low-voltage unit, to the second low-voltage unit, and to the third low-voltage unit, the plurality of terminals including:
two output terminals; and
a first interconnection terminal connected to the first low-voltage unit;
a second interconnection terminal connected to the second low-voltage unit;
a third interconnection terminal connected to the second low-voltage unit; and
a fourth interconnection terminal connected to the third low-voltage unit,
a first conductor assembly disposed on a first side of the battery pack, the first conductor assembly comprising:
a first conductor selectively electrically connected to the first interconnection terminal and to the second interconnection terminal;
a first cover connected to the first conductor, the first cover being made of electrically non-conductive material, and the first cover covering:
the first conductor;
the first interconnection terminal; and
the second interconnection terminal,
a second conductor assembly disposed on a second side of the battery pack, the second conductor assembly comprising:
a second conductor selectively electrically connected to the third interconnection terminal and the fourth interconnection terminal; and
a second cover connected to the second conductor, the second cover being made of electrically non-conducting material, and the second cover covering:
the second conductor;
the third interconnection terminal; and
the fourth interconnection terminal,
with the first conductor electrically connected to the first interconnection terminal and to the second interconnection terminal, and the second conductor electrically connected to the third interconnection terminal and the fourth interconnection terminal, a voltage greater than a pre-determined voltage is present between two terminals of the plurality of terminals;
the first conductor assembly is configured to remove the first conductor together with the first cover, thereby;
electrically disconnecting the first conductor from the first interconnection terminal and from the second interconnection terminal;
providing access to the first interconnection terminal and to the second interconnection terminal;
the second conductor assembly is configured to remove the second conductor together with the second cover, thereby;
electrically disconnecting the second conductor from the third interconnection terminal and from the fourth interconnection terminal; and
providing access to the third interconnection terminal and to the fourth interconnection terminal;
the first conductor assembly is configured to install the first conductor together with the first cover, thereby:
electrically connecting the first conductor to the first interconnection terminal and to the second interconnection terminal; and
covering the first interconnection terminal and the second interconnection terminal,
in response to the first conductor being disconnected from the first interconnection terminal and from the second interconnection terminal, the voltage between any two terminals of the plurality of terminals is less than or equal to the pre-determined voltage
the second conductor assembly is configured to install the second conductor together with the second cover, thereby:
electrically connecting the second conductor to the third interconnection terminal and to the fourth interconnection terminal; and
covering the third interconnection terminal and the fourth interconnection terminal,
in response to the first conductor being disconnected from the first interconnection terminal and from the second interconnection terminal and the second conductor being disconnected from the third interconnection terminal and from the fourth interconnection terminal, the voltage between any two terminals of the plurality of terminals is less than or equal to the pre-determined voltage.

12. The battery pack of claim 11 wherein:
the first conductor is selectively mechanically fastened to the first interconnection terminal and to the second interconnection terminal; and
the second conductor is selectively mechanically fastened to the third interconnection terminal and to the fourth interconnection terminal.

13. The battery pack of claim 11, wherein the first conductor is encased in the first cover and the second conductor is encased in the second cover.

14. The battery pack of claim 11, wherein the plurality of terminals further comprises two other terminals, and the battery pack further comprises a connection unit having the two other terminals, such that the connection unit is selectively electrically connected to the first low-voltage unit, to the second low-voltage unit, and to the third low-voltage unit.

15. The battery pack of claim 14, wherein the connection unit includes at least one of a charger, an inverter, or a DC-DC converter.

16. The battery pack of claim 14, wherein the first low-voltage unit, the second low-voltage unit, the third low-voltage unit and the connection unit are mechanically connected to one another.

17. The battery pack of claim 11, wherein the pre-determined voltage is one of 50 volts or 60 volts.

18. The battery pack of claim 11, wherein at least one of:
the first conductor is a first busbar, and the second conductor is a second busbar; or
the first low-voltage unit is a first battery module, the second low-voltage unit is a second battery module and the third low-voltage unit is a third battery module.

19. The battery pack of claim 11, wherein at least one of the first low-voltage unit, the second low-voltage unit, or the third low-voltage unit includes at least two cells of lithium-ion type.

20. The battery pack of claim 11, wherein the cover further covers the two output terminals.
